(19) United States
(12) Patent Application Publication
(10) Pub. No.: US 2011/0191683 A1
(43) Pub. Date: Aug. 4, 2011

(54) Methods and Systems to Enhance Advisor-Client Communications

(76) Inventor: Daniel G. Dillard, Austin, TX (US)

(21) Appl. No.: 12/959,599

(22) Filed: Dec. 3, 2010

Related U.S. Application Data
(60) Provisional application No. 61/266,568, filed on Dec. 4, 2009.

(51) Int. Cl. G06F 3/01; G06F 15/16

(52) U.S. Cl. 715/719; 715/738

(57) ABSTRACT

Methods and systems enable an advisor to communicate with clients by email containing embedded video content where the video content has been vetted and approved by a compliance officer or function to reduce the likelihood that a problematic video with be disseminated to a client.

### CROSS REFERENCE TO RELATED APPLICATIONS

This application relates to, claims priority from and incorporates by reference the disclosure of U.S. provisional patent application Ser. No. 61/266,568, filed Dec. 4, 2009, by the same inventor.

### TECHNICAL FIELD

This disclosure relates generally to systems and methods for business advisor/client communications, and more particularly to email communications that incorporate a marketing or educational video.

### BACKGROUND

Broker/dealers and other advisors provide information and advice to clients in the area of their expertise, such as finance, real estate, business, technology and so forth. Internet technology allows advisers to communicate with client through a variety of media, including email. Technology also allows a digital video to be embedded in the body of an email and played back through a virtual video player. An advisor may create a video with a webcam or other suitable digital camera or maintain a library of archived videos on a computer hard drive.

Educational, marketing or personal videos provide an effective way to communicate information to clients. However, the content of some may cause problems for the advisor. For example, the content may contain copyrighted material for which dissemination permission has not been given, the video may contain trademark violations, the video may contain claims that are disallowed by law or regulation, or the video may be defamatory or otherwise have inappropriate content.

Described herein are methods and systems for an advisor to communicate with clients by email containing embedded video content where the video content has been vetted and approved by a compliance officer or function to reduce the likelihood that a problematic video with be disseminated to a client.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a schematic diagram of the components of an exemplary embodiment of a client communications system of the present disclosure.

FIG. 2 is a schematic diagram of the components of a compliance office user interface of an exemplary embodiment of a client communications system of the present disclosure.

FIG. 3 is a schematic flow diagram of a user interface and process flow for an exemplary embodiment of a client communications system of the present disclosure.

FIG. 4 is a schematic flow diagram of an advisor interface and process flow for an exemplary embodiment of a client communications system of the present disclosure.

FIG. 5 is a schematic process flow diagram for a web-based user login method of an exemplary embodiment of a client communications system of the present disclosure.

FIG. 6 is a schematic diagram of the components of an administrator interface of an exemplary embodiment of a client communications system of the present disclosure.

### DETAILED DESCRIPTION

Advisors, such a broker/dealer, provide information and advice to clients in the area of their expertise, such as finance, real estate, business, technology and so forth. Technology allows advisers to communicate with client through a variety of media, including email. Technology also allows video to be embedded in the body of an email and played back through a virtual video player. An advisor may create a video with a webcam or other suitable digital camera or maintain a library of archived videos on a computer hard drive.

Although videos can provide an effective way to provide information to clients, the content of some may cause problems for the advisor. For example, the content may contain copyrighted material for which dissemination permission has not been given, the video may contain trademark violations, the video may contain claims that are disallowed by law or regulation, or the video may be defamatory or otherwise have inappropriate content.

Described herein are methods and systems for an advisor to communicate with clients by email containing embedded video content where the video content has been vetted and approved by a compliance officer or function to reduce the likelihood that a problematic video with be disseminated to a client.

In a specific alternative exemplary embodiment, the client email may contain a link to an internet web portal having a client dashboard where the client may view a video, view a prospectus and ask questions of the adviser. Additional specific embodiments provide a website at which a client may login to perform the above functions. Yet another embodiment provides an “app” installed on a computer or mobile device for the client to perform such functions.

Videos of the present system and methods may be education or marketing videos. In a preferred embodiments, educational and marketing videos have no set click limit and maybe viewed as many times as the client likes. However, such videos have an expiration date so that the video expires pursuant to prospectus or vendor request. Alternative embodiments provide a “drip list” in which a client is scheduled to receive an educational video on schedule such as once a week.

Videos may also be personal videos, such as personal holiday greeting from the advisor to his or her clients. In a preferred embodiment, personal videos expire after a pre-set number of views by the client. A personal video that expires, therefore, may be safer than a voicemail left for a client.

An advantageous feature of the present system and methods is participation of a compliance officer to vet the videos for compliance with the advisor's company's policies and government regulations prior to making any video available to be viewed by a client. Compliance may in include the participation of the Financial Industry Regulatory Authority (FINRA) and the issuance of FNRA letters.

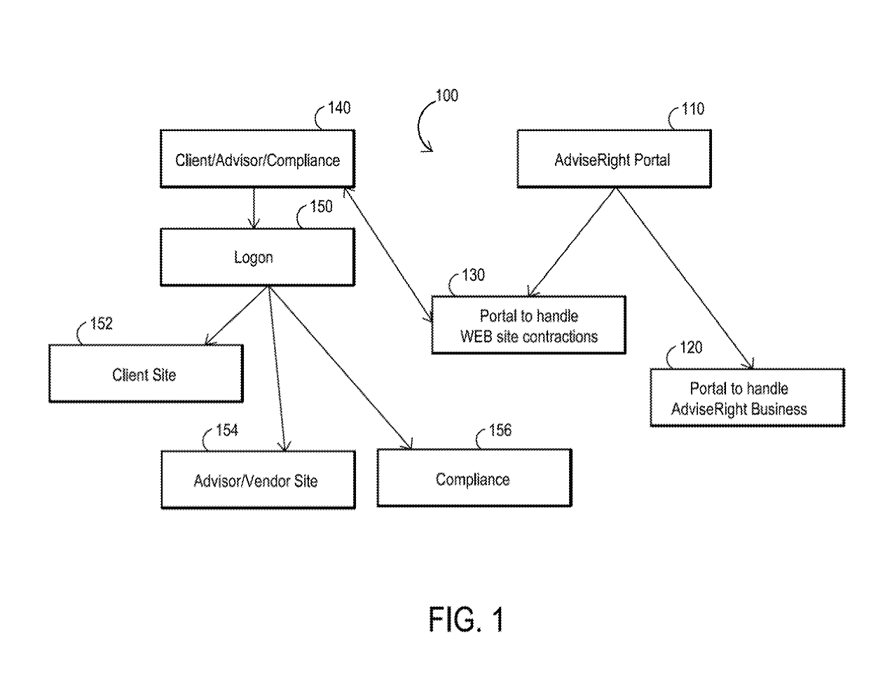

The drawings provide further explanation of the present system and methods. FIG. 1 is a schematic diagram of the components of an exemplary embodiment of a client communications system 100 of the present disclosure. Website portal 100 provides system admin function 120 and portal 130 to system functions, including without limitation, for example, Client/Advisor compliance 140, logon functions 150, client site 152, Advisor/Vendor site 154 and Compliance 156.

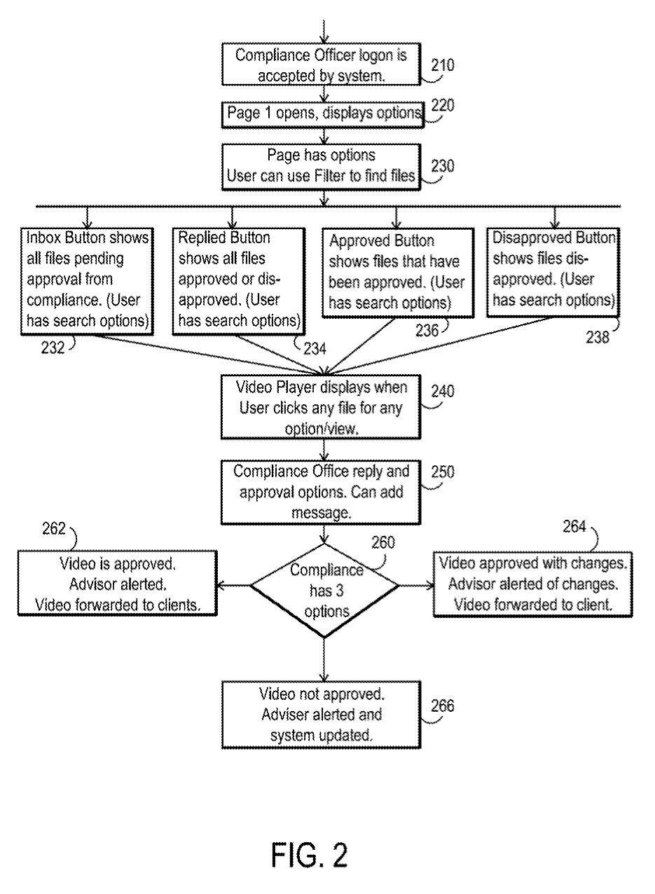

FIG. 2 is a schematic diagram of the components of a compliance office user interface of an exemplary embodiment of a client communications system of the present disclosure. Compliance Officer logon is accepted by the system 210, Home page displays user interface 220 as well as, for example, search function and filter to find files 230. Functions include without limitation Communications Inbox 232; Replied function 234 shows files approved or disapproved; Approved window 236 shows approved files; Disapproved window 238 shows disapproved files.

Activating any file, for instance, causes a virtual video player to be displayed 240. Video player provides compliance approval function and messaging functionality 250.

Compliance involves three functions: Approved 262, approved with changes 264 and not approved 266.

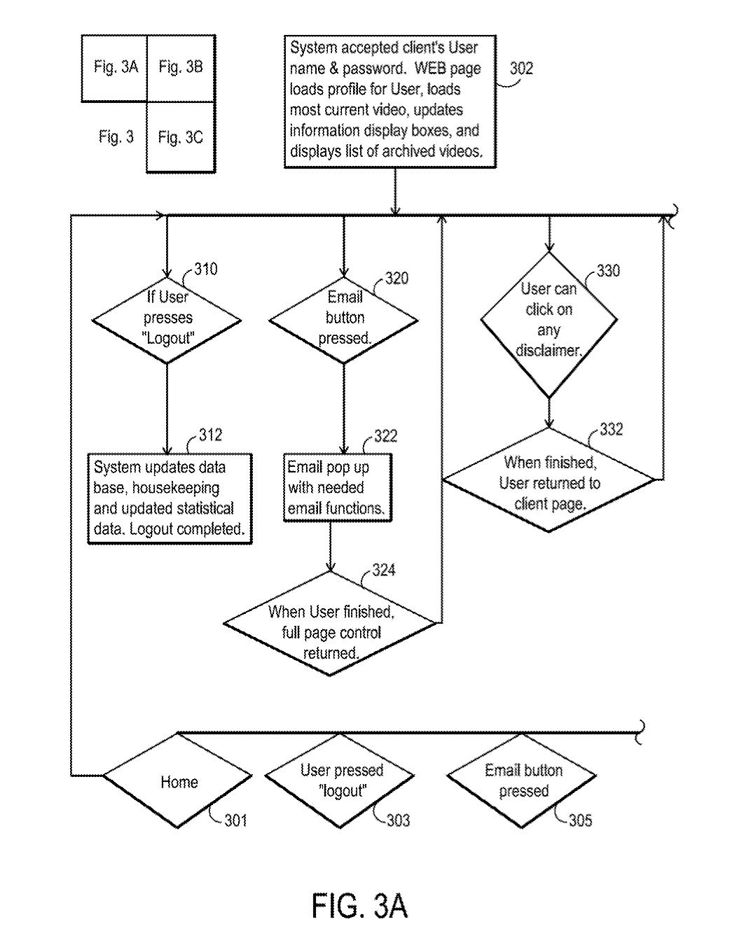

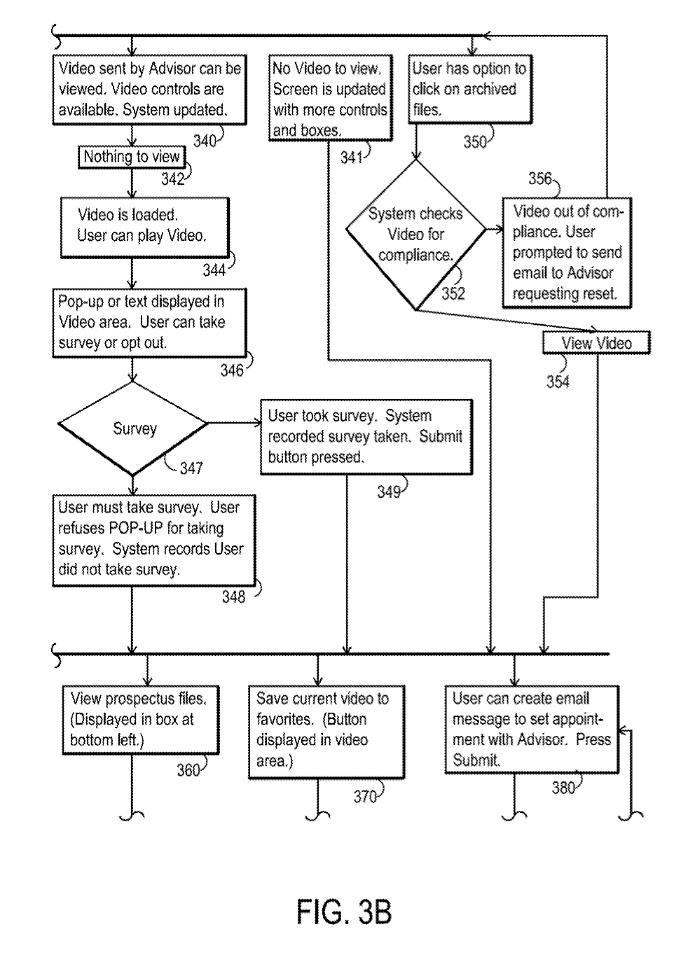

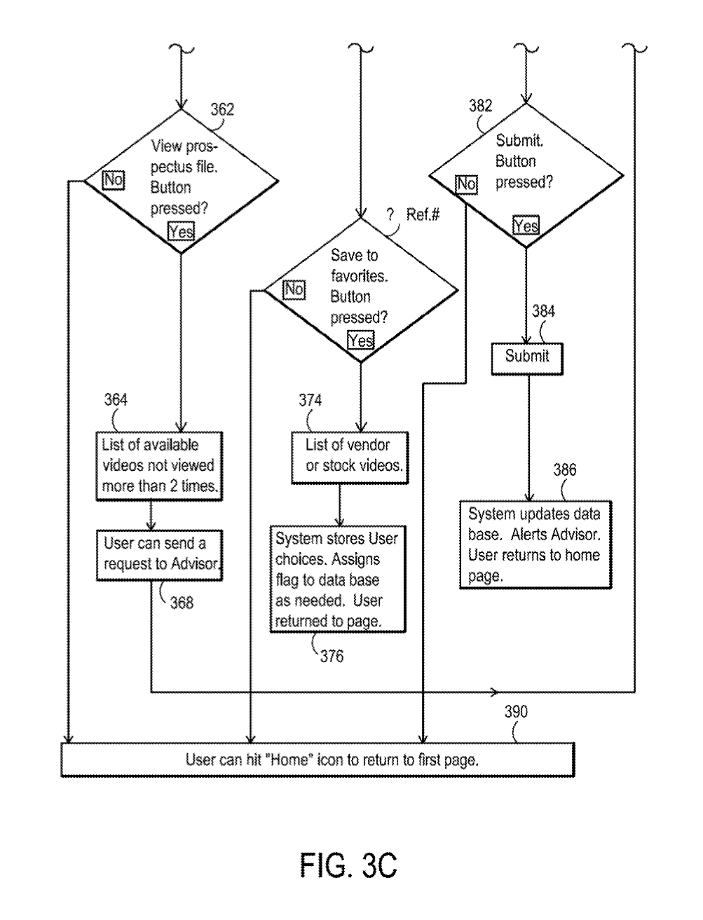

FIG. 3 is a schematic flow diagram of a user interface and process flow for an exemplary embodiment of a client communications system of the present disclosure. User login 302 causes the browser to load the user profile, updates information, provides a list of archived videos and provides a user interface. For example logout 310 updates the system data, executes housekeeping functions and logs the user out of the system. Email interface 320 produces an email pop up window 322 with email controls. Closing the email window or sending an email returns the user to full page interface 324. Disclaimer interface 330 provides access to one or more disclaimer and closing the disclaimer window returns the user to the full page interface 332.

Video control 340 allows a video to be viewed, provides video controls and updates the system. If there is no video 341, the user may return to the home interface 301. If there is a video 342, the video is loaded in to a virtual video player to be viewed 344. Text is displayed in the video area of the screen or alternatively in a pop up 346 and a user may take a survey 347, for example, and the system notes that the survey was taken 349, or the user may opt out 348, which is also noted by the system.

Archived video files 350 may be viewed 354 or checked for compliance 352 and if out of compliance an archived video may be submitted to the advisor or administrator for reset 356.

Additional interface features include without limitation prospectus view 360, favorite video 370 and email creation 380.

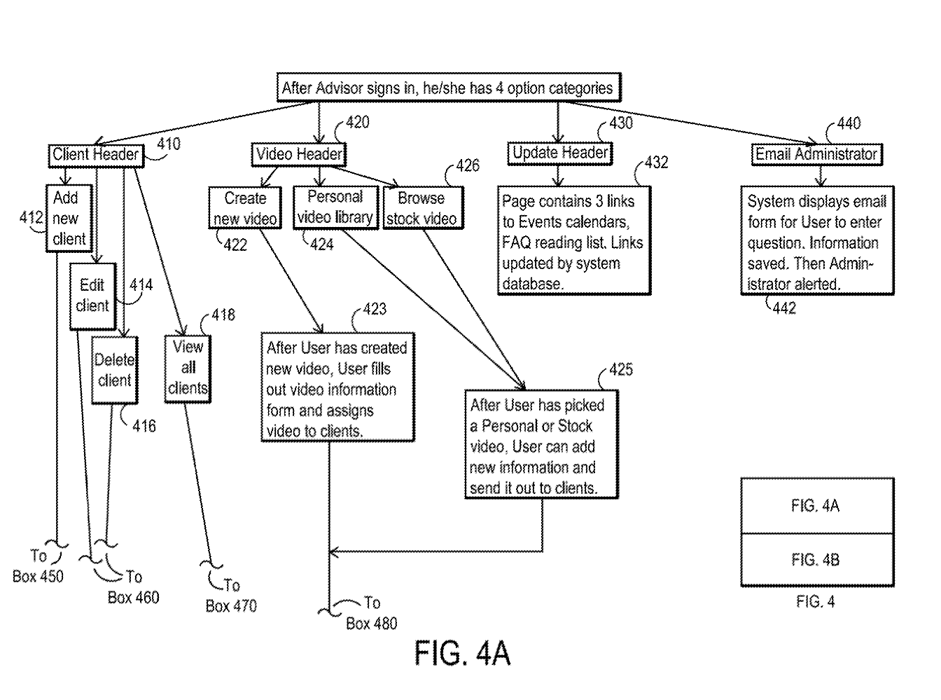

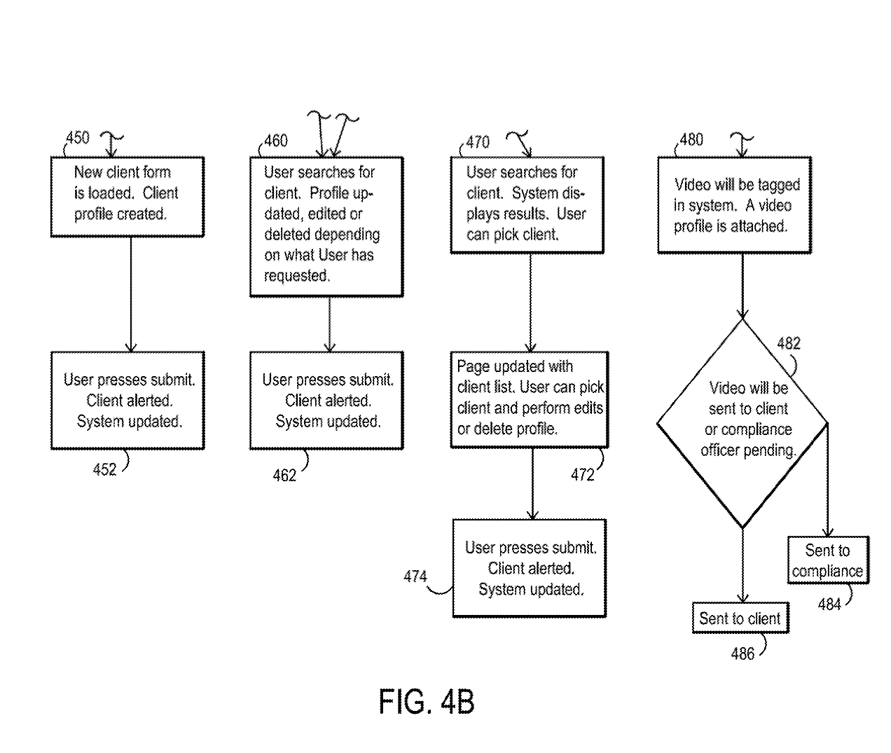

FIG. 4 is a schematic flow diagram of an advisor interface and process flow for an exemplary embodiment of a client communications system of the present disclosure. A user signs into the system 402 on a networked, computer, for example. After logon, a user interface presents four options:

Client Header 410, Video Header 420, Update Header 430, and Email Administrator 440. Client header 410 provides various functions to manage client information. An upper tier of functions includes without limitation, for example, add client 412, Edit Client 414, Delete Client 416, and View All Clients, 418. Add New client 412 opens a new client interface to create a new client profile 450. After the profile is created, it is submitted to the system and the system's records are updated 452. The new client is notified.

Edit Client 414 and Delete Client 416 prompts the system to search for the client 460. The client's profile is updated (if edited) or deleted. The system is updated 462 and the client is notified.

View All clients 470 prompts the system to search for the client(s) and displays the results 470. User may select one or more client record 472 and may perform operations on the selected record(s) such as edit or delete. The altered record is submitted 474, the system is updated and the client is notified.

Video Header 420 provides user interfaces to Create a New Video 422, Access a Personal Video Library 424, and to Browse Stock Video 426. The Create a New Video 422 provides a user interface 423 to enter information about a new video and to assign the video to one or more clients. The new video may be tagged and be provided with a video profile 480. Compliance 482 allows a new video to be reviewed for compliance with company policies. The new video is sent to compliance 484 and to the client 486.

Personal Video Library 424 and Browse Stock Video 426 provide an inventory list of one or more video which may be selected by a user 425 to enter or edit information about the video. Changes to the video information are saved and the video is tagged 480.

Update Header 430 provides a user interface 432 that may contain, for example, links to event calendars, FAQ pages, and reading lists. Information and links are automatically updated in specific embodiments.

Email administrator 440 provides a user interface 442 to display email form for a user to email a question to the system administrator.

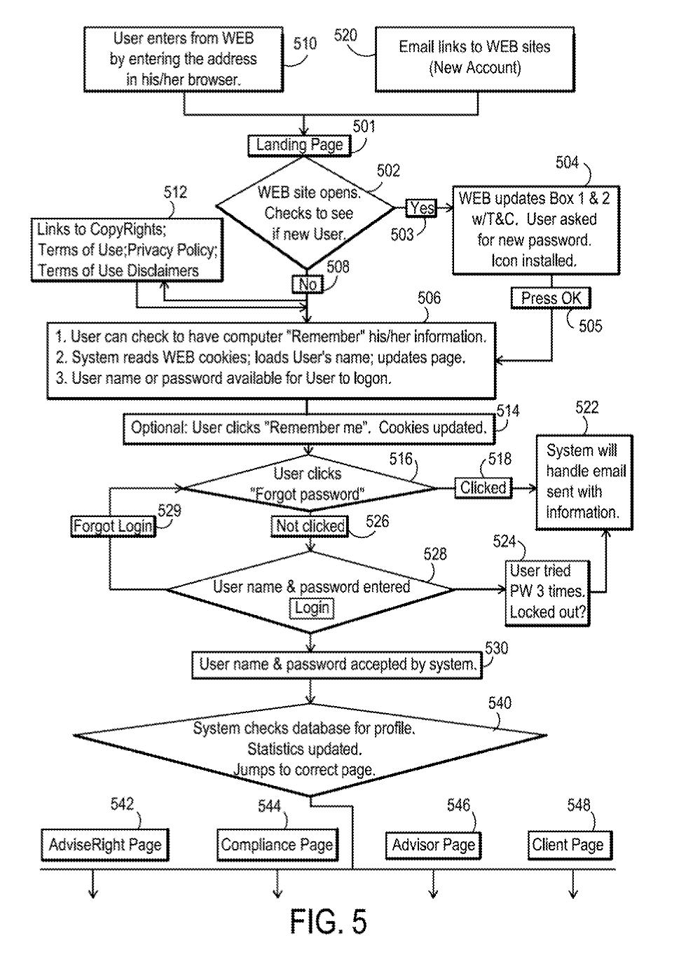

FIG. 5 is a schematic process flow diagram for a web-based user login method of an exemplary, embodiment of a client communications system of the present disclosure. User accesses the web portal of the system with a URL in a browser window 510 or from a hypertext link 520 to open the home page of the system 501. The home determines whether the user is a new user 502. A new user is prompted to create a password and the system creates an icon for the new user 504. The new user enters the new user information 505 to be directed to the system home page. The home page provides the option for the system to “remember” the user. Checks cookies to confirm the computer ID and stores the user ID to be available for future use 506. If on a new computer, the user opts for “remember me” and system updates cookies to the new computer. Additionally, the home page provides legal terms and policies 512.

The home page administers passwords and user ID 529. Provides “forgot password” 516, 518 with mechanism for password to be provided to user 522. System locks a user out after three failed password attempts 524. If login information not forgotten 526 or otherwise resolved 529, 522, user enters login information 528, which is accepted by the system 530. Upon login, the system updates data and profile 540 and presents portals to system functions such as user page 542, compliance 544, Advisor page 546 and Client page 548.

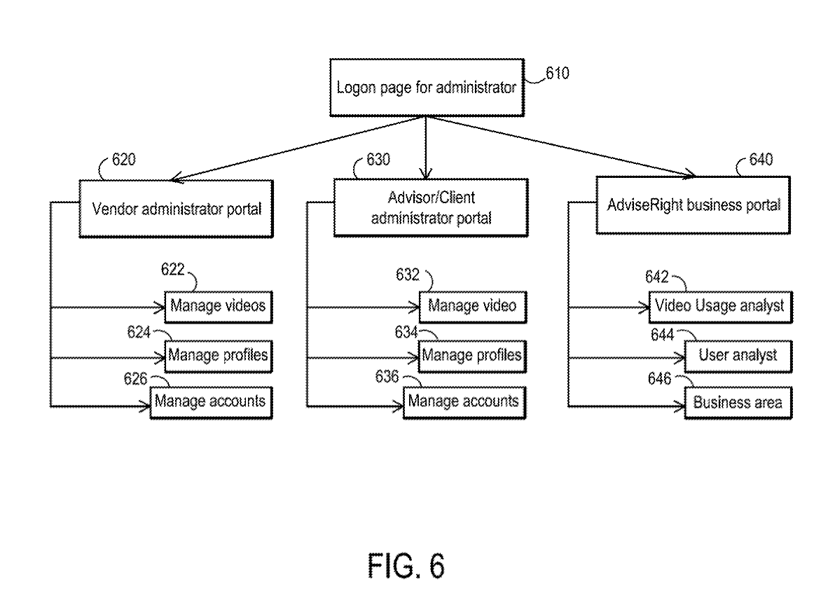

FIG. 6 is a schematic diagram of the components of an administrator interface of an exemplary embodiment of a client communications system of the present disclosure. An administrator interface of the present disclosure provides, for example and without limitation, administrator logon function 610; vendor administrator portal 620; Advisor/Client portal 630; and Business portal 640.

Vendor administrator portal 620 provides without limitation administrative functions for managing vendor videos, 622, vendor profiles 624, and vendor accounts 626.

Advisor/client portal 630 provides without limitation functions to administer advisor/client videos 632; advisor/client profiles 634; and advisor/client profiles 636.

Administrator business portal provides without limitation functions to administer video usage analysis 642; analysis of users 644; and administration of the business area of the system website 646.

In addition to the foregoing embodiments, the present disclosure provides programs and software stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Many modifications and other embodiments of the systems and methods described herein will come to mind to one skilled in the art to which this disclosure pertains having the benefit of the teachings presented in the foregoing descriptions and the associated drawings. Therefore, it is to be understood that the disclosure is not to be limited to the Methods and Systems to Enhance Advisor-Client Communications specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for an advisor to communicate with a client via the internet, the system comprising:
an internet portal that provides user access to the internet;
a user interface accessible from the portal; wherein the user interface provides controls and access to communication files;
means in the user interface control for an advisor to create a client email with an embedded video;
means to vet the video prior to transmission for compliance with requirements; and
means to administer the data and settings of the system.

2. The system of claim 1, further comprising a library of archive videos for a user to select from to include in a client email.

3. The system of claim 1, further comprising means for a user to create and archive a video.

4. The system of claim 1, wherein the requirements with which a video should comply comprise policies of the user's business.

5. The system of claim 1, wherein the requirements with which a video should comply comprise government regulations.

6. The system of claim 1, wherein the requirements with which a video should comply comprise statutes.

7. The system of claim 1, wherein the means to vet for compliance comprises a compliance officer who evaluates the video prior to its transmission to a client.

8. A method for an advisor to communicate with a client via the Internet, the method comprising the steps of:
providing an internet portal that provides user access to the internet;
providing a user interface accessible from the portal; wherein the user interface provides controls and access to communication files;
providing means in the user interface control for an advisor to create a client email with an embedded video;
providing means to vet the video prior to transmission for compliance with requirements; and
providing means to administer the data and settings of the system.

9. The method of claim 8, further comprising providing a library of archive videos for a user to select from to include in a client email.

10. The method of claim 8, further comprising providing means for a user to create and archive a video.

11. The method of claim 1, wherein the requirements with which a video should comply comprise policies of the user's business.

12. The method of claim 8, wherein the requirements with which a video should comply comprise government regulations.

13. The method of claim 8, wherein the requirements with which a video should comply comprise statutes.

14. The method of claim 8, wherein the means to vet for compliance comprises a compliance officer who evaluates the video prior to its transmission to a client.

15. The method of claim 8, wherein one or more of the steps the method are executed by software running on a computer.
